(19) United States
(12) Patent Application Publication
(10) Pub. No.: US 2025/0202583 A1
(43) Pub. Date: Jun. 19, 2025

(54) OPTICAL TRANSMISSION SYSTEM AND OPTICAL TRANSMISSION METHOD

(71) Applicant: NITTO DENKO CORPORATION, Osaka (JP)

(72) Inventors: Yugo KASEDA, Osaka (JP); Yoshinori OSAKI, Osaka (JP); Takeshi TANAKA, Osaka (JP)

(73) Assignee: NITTO DENKO CORPORATION, Osaka (JP)

(21) Appl. No.: 18/846,512

(22) PCT Filed: Mar. 29, 2023
(86) PCT No.: PCT/JP2023/012727

§ 371 Date: Sep. 12, 2024

(30) Foreign Application Priority Data
Mar. 31, 2022 (JP) 2022-059279

(51) Int. Cl. H04B 10/2575; H04B 10/077

(52) U.S. Cl. CPC H04B 10/25759; H04B 10/077

(57) ABSTRACT

An optical transmission system converts a first electrical signal to an optical signal, transmits the converted optical signal, and converts the transmitted optical signal to a second electrical signal. The optical transmission system includes an electrical-optical conversion device, an optical transmission line, and an optical-electrical conversion device. The first electrical signal includes a communication signal having a high frequency of more than 10 GHz and 100 GHz or less. The optical transmission system further includes an additional signal generation device that generates a low-frequency additional signal having a frequency of 1. Hz or more and 9 MHz or less. The electrical-optical conversion device converts the first electrical signal including the additional signal generated in the additional signal generation device and the communication signal to an optical signal.

### TECHNICAL FIELD

The present invention relates to an optical transmission system and an optical transmission method.

### BACKGROUND ART

There is a known optical transmission system including a laser chip, an optical fiber, and an optical isolator interposed therebetween (for example, see Patent Document 1 below). In the optical transmission system described in Patent Document 1, the light exiting from the laser chip passes through the optical isolator and thereafter enters into an optical fiber. The optical isolator blocks the light traveling in a backward direction while only transmitting the light traveling in a forward direction. Therefore, in the optical transmission system, the optical isolator attenuates the light returning from the optical fiber.

### CITATION LIST

### Patent Document

Patent Document 1: Japanese Unexamined Patent Publication No. 2003-14992

### SUMMARY OF THE INVENTION

### Problem to be Solved by the Invention

Depending on the use and purpose, the optical transmission system is required to suppress the variation in signal quality with respect to time. The signal quality includes CNR (carrier/noise ratio). The signal quality can be referred to as signal properties. The optical transmission system of Patent Document 1 suppresses the above-described variation by attenuating the above-described returning light with the optical isolator. However, there is a disadvantage that such an optical isolator is expensive and complicates the structure of the optical transmission system.

The present invention provides an optical transmission system and an optical transmission method that simplifies the structure and lowers the cost while being able to suppress the variation in signal quality with respect to time.

### Means for Solving the Problem

The present invention [1] includes an optical transmission system that converts a first electrical signal to an optical signal, transmits the converted optical signal, and converts the transmitted optical signal to a second electrical signal, the optical transmission system comprising: an electric-photo conversion device that converts the first electrical signal to the optical signal; an optical transmission line that transmits the optical signal converted in the electric-photo conversion device; and an optical-electrical conversion device that converts the optical signal transmitted from the optical transmission line to the second electrical signal, wherein the first electrical signal includes a communication signal having a high frequency of more than 10 GHz and 100 GHz or less, wherein the optical transmission system further includes an additional signal generation device that generates a low-frequency additional signal having a frequency of 1 Hz or more and 9 MHz or less, and wherein the electric-photo conversion device converts the first electrical signal including the additional signal generated in the additional signal generation device and the communication signal to the optical signal.

In this optical transmission system, the first electrical signal including a low-frequency additional signal generated in the additional signal generation device and having a frequency of 1 Hz or more and 9 MHz or less is converted into an optical signal, and thus the variation in signal quality with respect to time can be suppressed.

In addition, this optical transmission system does not need to include an optical isolator as described in Patent Document 1, and only needs to include an additional signal generation device that generates a low-frequency additional signal having a specific frequency, and thus has the structure is simple and the cost is low.

The present invention [2] includes the optical transmission system described in the above-described [1], wherein the additional signal has an intensity of 70 dBμV or less.

In this optical transmission system, the additional signal has an intensity of 70 dBμV or less, and thus the variation in signal quality with respect to time can further be suppressed.

The present invention [3] includes the optical transmission system described in the above-described [1] or [2], further comprising: a communication signal generation device that generates the communication signal.

The present invention [4] includes an optical transmission method of converting a first electrical signal to an optical signal, transmitting the converted optical signal, and converting the transmitted optical signal to a second electrical signal, wherein the first electrical signal includes a communication signal having a high frequency of more than 10 GHz and 100 GHz or less, wherein the optical transmission method further includes: a first step of converting the first electrical signal to the optical signal; a second step of transmitting the optical signal converted in the first step; a third step of converting the optical signal transmitted in the second step to the second electrical signal; and a fourth step of generating a low-frequency additional signal having a frequency of 1 Hz or more and 9 MHz or less, and wherein in the first step, the first electrical signal including the additional signal generated in the fourth step and the communication signal is converted to the optical signal.

In the first step of the optical transmission method, the first electrical signal including a low-frequency additional signal having a frequency of 1 Hz or more and 9 MHz or less is converted to an optical signal, and thus the variation in signal quality with respect to time can be suppressed.

In addition, in the fourth step of the optical transmission method, a low-frequency additional signal having a specific frequency is generated, and thus the structure is simple and the cost is low.

The present invention [5] includes the optical transmission method described in the above-described [4], wherein the additional signal has an intensity of 70 dBμV or less.

In this optical transmission method, the additional signal has an intensity of 70 dBμV or less, and thus the variation in signal quality with respect to time can further be suppressed.

The present invention [6] includes the optical transmission method described in the above-described [4] or [5], further comprising: a fifth step of generating the communication signal.

### Effects of the Invention

The optical transmission system and optical transmission method of the present invention simplifies the structure and lowers the cost while being able to suppress the variation in signal quality with respect to time.

### BRIEF DESCRIPTION OF THE DRAWINGS

FIG. 1 shows one embodiment of the optical transmission system of the present invention.

FIG. 2 shows the optical transmission system of a variation.

FIG. 3 shows the optical transmission system of a variation.

### DESCRIPTION OF THE EMBODIMENT

### One Embodiment of Optical Transmission System

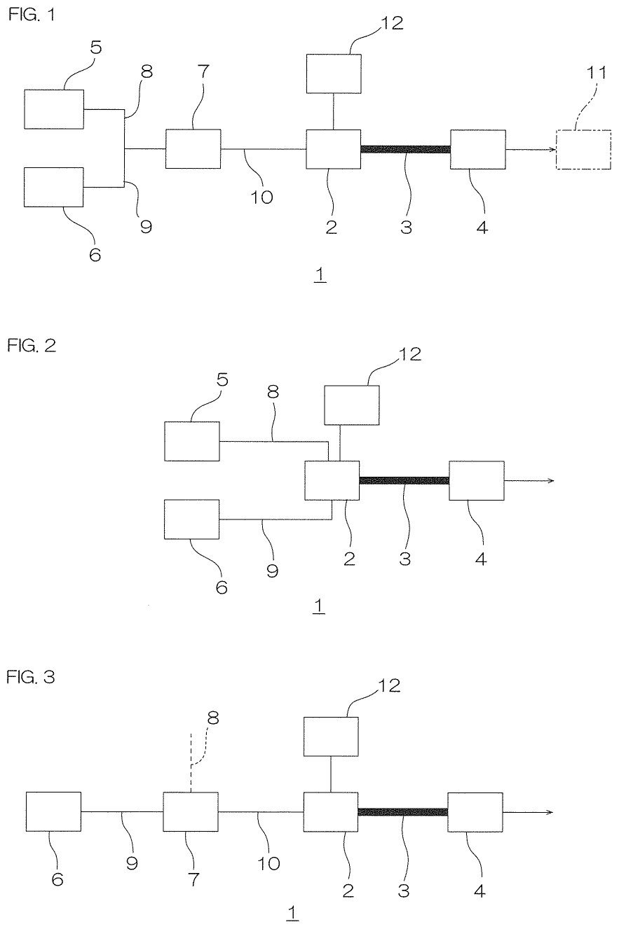

One embodiment of the optical transmission system of the present invention is described with reference to FIG. 1. An optical transmission system 1 converts a first electrical signal to an optical signal, transmits the converted optical signal, and convers the transmitted optical signal to a second electrical signal. Hereinafter, each signal is described.

<First Electrical signal>

In the present invention, the first electrical signal includes an additional signal.

### <Additional Signal>

An additional signal is constantly included in the first electrical signal regardless of the passage of time. In other words, at any time, the first electrical signal includes an additional signal.

The additional signal is a low-frequency signal. The additional signal has a frequency of 1 Hz or more and 9 MHz or less. When the additional signal has a frequency of less than 1 Hz or more than 9 MHz, the variation in the signal quality described below cannot sufficiently be suppressed. The additional signal has a frequency of preferably 10 Hz or more, more preferably 100 Hz or more, even more preferably 1 kHz or more, particularly preferably 10 kHz or more. Furthermore, the additional signal has a frequency of preferably 1 MHz or less, more preferably 500 kHz or less, even more preferably 300 kHz or less.

The additional signal has an intensity of, for example, 1000 dBμV or less, preferably 100 dBμV or less, more preferably 80 dBμV or less, even more preferably 70 dBμV or less. The additional signal has an intensity of, for example, 10 dBμV or more, preferably 40 dBμV or more.

When the intensity of the additional signal is the above-described lower limit or more and the above-described upper limit or less, the variation in signal quality with respect to time can further be suppressed.

### <Communication Signal>

The first electrical signal further includes a communication signal including the information to be communicated. The communication signal is a high-frequency signal. The communication signal is added to or superimposed on the additional signal above described. The additional signal does not include the information to be communicated, and thus may be referred to as a “non-communication signal.” The communication signal is transmitted depending on the passage of time. In other words, there are a time when a communication signal is transmitted and a time when a communication signal is not transmitted. Specifically, when a communication signal is not transmitted (when the communication signal is OFF) in the optical transmission system 1, the first electrical signal does not include a communication signal, and only includes an additional signal. On the other hand, when a communication signal is transmitted (when the communication signal is ON) in the optical transmission system 1, the first electrical signal includes a communication signal and an additional signal.

Examples of the communication signal include an analog signal and a digital signal. Examples of the analog signal includes an RF signal. The RF signal includes electromagnetic waves having a frequency band used for wireless communication. The RF signal is transmitted, for example, by a frequency-division multiplex system. The frequency-division multiplex system is a system that carries out the modulation of the communication signals, and then concurrently multiplies the modulated communication signals on the frequency axis to transmit a plurality of channels. Examples of the RF signal include multiple CW waves (a plurality of single-frequency signals), and a single CW wave (one single-frequency signal). The above-described RF signal and method are described, for example, in Japanese Unexamined Patent Publication No. 2020-096363.

The communication signal has a frequency of, for example, more than 10 GHZ, preferably 11 GHz or more, more preferably 12 GHz or more, even more preferably 15 GHz or more, particularly preferably 20 GHz or more. Furthermore, the communication signal has a frequency of 100 GHz or less, preferably 50 GHz or less, more preferably 40 GHz or less. The communication signal has a frequency higher than that of the above-described additional signal. The ratio of the frequency of the communication signal to the frequency of the additional signal is, for example, 1.1×10⁴ or more, preferably 5×10⁴ or more, and, for example, 10⁸ or less, preferably 5×10⁷ or less.

The intensity of the communication signal is not limited. The intensity of the communication signal is appropriately set depending on the use and purpose of the optical transmission system 1.

### <Optical Signal and Second Electrical Signal>

The optical signal is a signal obtained by converting the above-described first electrical signal. The second electrical signal is a signal obtained by converting the above-described optical signal. The optical signal and the second electrical signal include at least the above-described additional signal.

### <Structure of Optical Transmission System 1>

As shown in FIG. 1, the optical transmission system 1 includes an electrical-optical conversion device 2, an optical transmission line 3, and an optical-electrical conversion device 4. Furthermore, the optical transmission system 1 includes a communication signal generation device 5, an additional signal generation device 6, and a synthesis device 7.

### <Electrical-Optical Conversion Device 2>

The electrical-optical conversion device 2 is capable of converting the above-described first electrical signal to an optical signal. The electrical-optical conversion device 2 is not limited. Examples of the electrical-optical conversion device 2 include TOSA. TOSA is an optical transmission subassembly (Transmitter Optical SubAssebmly). The above-described electrical-optical conversion device 2 includes, for example, a light source. Examples of the light source include a laser diode. Examples of the laser diode include a Vertical Cavity Surface Emitting Laser (VCSEL). Furthermore, the electrical-optical conversion device 2 is connected to a direct current generation device 12. Examples of the direct current generation device 12 include a direct current source.

### <Optical Transmission Line 3>

The optical transmission line 3 is capable of transmitting the optical signal converted in the electrical-optical conversion device 2. The optical transmission line 3 extends in a transmission direction. An upstream-side end portion of the optical transmission line 3 in the transmission direction is connected to the electrical-optical conversion device 2. The optical transmission line 3 is not limited. Examples of the optical transmission line 3 include an optical fiber. Examples of the optical fiber include a plastic optical fiber and a glass optical fiber. Examples of the mode of the optical transmission line 3 include multi-mode and single-mode.

### <Optical-electrical Conversion Device 4>

The optical-electrical conversion device 4 is capable of converting the optical signal transmitted from the optical transmission line 3 to a second electrical signal. The optical-electrical conversion device 4 is connected to a downstream-side end portion of the optical transmission line 3 in the transmission direction. The optical-electrical conversion device 4 is not limited. Examples of the optical-electrical conversion device 4 include ROSA. ROSA is an optical reception subassembly (Receiver Optical SubAssebmly). Furthermore, the above-described optical-electrical conversion device 4 includes, for example, a photodiode (PD).

### <Communication Signal Generation Device 5>

The communication signal generation device 5 is capable of generating the above-described communication signal. The communication signal generation device 5 is connected to the electrical-optical conversion device 2 through the synthesis device 7 described below. A communication line 8 is wired between the communication signal generation device 5 and the synthesis device 7. The communication signal generation device 5 is not limited. Examples of the communication signal generation device 5 include an antenna and an antenna substrate that are capable of receiving an RF signal. Furthermore, examples of the communication signal generation device 5 include a multi-signal generation device.

### <Additional Signal Generation Device 6:

The additional signal generation device 6 is capable of generating the above-described additional signal. The additional signal generation device 6 is connected to the electrical-optical conversion device 2 and the communication signal generation device 5 through the synthesis device 7 described below. The additional line 9 is wired between the additional signal generation device 6 and the synthesis device 7. A downstream-side portion of the additional line 9 in the transmission direction forms a common line with a downstream-side portion of the communication line 8 in the transmission direction. The additional signal generation device 6 is not limited. Examples of the additional signal generation device 6 include a low-frequency signal generation device. Examples of the low-frequency signal generation device include a multi-signal generation device.

### <Synthesis Device 7>

The synthesis device 7 is capable of synthesizing (superimposing) the communication signal generated in the communication signal generation device 5 and the additional signal generated in the additional signal generation device 6. The synthesis device 7 is connected to the communication signal generation device 5 through the communication line 8. Furthermore, the synthesis device 7 is connected to the additional signal generation device 6 through the additional line 9. The connection line 10 is wired between the synthesis device 7 and the electrical-optical conversion device 2. Thus, the synthesis device 7 is connected to the electrical-optical conversion device 2 through the connection line 10.

### <Optical Transmission (Optical Transmission Method) by Optical Transmission System 1)>

Next, (an optical transmission method) by the optical transmission system 1 is described.

### <Operation When Communication Signal is OFF>

In this optical transmission system 1, the communication signal generation device 5 does not constantly generate a communication signal, in other words, the communication signal is OFF. On the other hand, in this optical transmission system 1, the additional signal generation device 6 constantly generates the above-described additional signal. In other words, a fourth step is carried out.

Then, the additional signal generated in the additional signal generation device 6 is input to the electrical-optical conversion device 2 through the additional line 9, the synthesis device 7, and the connection line 10. When passing through the synthesis device 7, the additional signal is processed so as to be included in the first electrical signal. In other words, the above-described first electrical signal including the additional signal is input to the electrical-optical conversion device 2.

The electrical-optical conversion device 2 converts the above-described first electrical signal to an optical signal. In other words, a first step is carried out. The electrical-optical conversion device 2 converts the first electrical signal including the above-described low-frequency additional signal to a light. At the time, the electrical-optical conversion device 2 uses the direct current input from the direct current generation device 12. Subsequently, the electrical-optical conversion device 2 inputs the converted optical signal to the optical transmission line 3.

The optical transmission line 3 transmits and inputs the input optical signal to the optical-electrical conversion device 4. In other words, a second step is carried out. Examples of the method of transmitting the optical signal include a multi-mode method and a single-mode method.

The optical-electrical conversion device 4 converts the optical signal input from the optical transmission line 3 to a second electrical signal. In other words, a third step is carried out. The second electrical signal may be the same as or different from the above-described first electrical signal. The second electrical signal is input to an external device 11 shown with a phantom line. Examples of the external device 11 include an image display device. Examples of the image display device include a television and a recorder.

### <Operation When Communication Signal Is ON>

When the communication signal is ON, the communication signal generation device 5 generates a communication signal. In other words, the fifth step is carried out. Even at the time, the additional signal generation device 6 continuously generates the above-described additional signal. In other words, the fourth step is carried out.

The communication signal generated in the communication signal generation device 5 and the additional signal generated in the additional signal generation device 6 are input to the synthesis device 7 through the communication line 8 and the additional line 9, respectively. The synthesis device 7 synthesizes the first electrical signal including the communication signal and the additional signal from them. In other words, in the synthesis device 7, the additional signal is added to (superimposed on) the communication signal to synthesize a first electrical signal. The first electrical signal synthesized in the synthesis device 7 is input to the electrical-optical conversion device 2 through the connection line 10.

The conversion from a first electrical signal to an optical signal by the electrical-optical conversion device 2 (the first step), the transmission of the optical signal by the optical transmission line 3 (the second step), and the conversion from the optical signal to a second electrical signal by the optical-electrical conversion device 4 (the third step) when the signal is ON are the same as those when the communication signal is OFF as describe above, respectively. However, the first electrical signal in the first step includes an additional signal and a communication signal.

### Operations and Effects of One Embodiment

In this optical transmission system 1, a first electrical signal that includes a low-frequency additional signal generated in the additional signal generation device 6 and having a frequency of 1 Hz or more and 9 MHz or less is converted to an optical signal, and thus the variation in signal quality with respect to time can be suppressed.

In addition, the optical transmission system 1 does not need to include an optical isolator as described in Patent Document 1, and only needs to include an additional signal generation device 6 that generates a low-frequency additional signal having a specific frequency, and thus the structure is simple and the cost is low.

In this optical transmission system 1, when the additional signal has an intensity of 70 dBμV or less, the variation in signal quality with respect to time can further be suppressed. In the first step of the optical transmission method of one embodiment, a first electrical signal including a low-frequency additional signal having a frequency of 1 Hz or more and 9 MHz or less is converted to an optical signal, and thus the variation in signal quality with respect to time can be suppressed.

In addition, in the fourth step of the optical transmission method, a low-frequency additional signal having a specific frequency is generated, and thus the structure is simple and the cost is low.

In this optical transmission method, when the additional signal has an intensity of 70 dBμV or less, the variation in signal quality with respect to time can further be suppressed.

### <Variations>

In variations, the same members and steps as in the above-described one embodiment are given the same numerical references, and the detailed descriptions thereof are omitted. Furthermore, each of the variations can have the same operations and effects as those of one embodiment unless especially described otherwise. Furthermore, one embodiment and the variations can appropriately be combined.

As shown in FIG. 2, the optical transmission system 1 does not separately include a synthesis device 7, and the electrical-optical conversion device 2 takes the function of the synthesis device 7. In other words, the electrical-optical conversion device 2 also functions as a synthesis device. The communication signal generation device 5 is connected to the electrical-optical conversion device 2 through the communication line 8. The additional signal generation device 6 is connected to the electrical-optical conversion device 2 through the additional line 9.

As shown in FIG. 3, the optical transmission system 1 may not include a communication signal generation device 5. In the variation of FIG. 3, a communication signal is input from outside to the synthesis device 7 through the communication line 8 shown with a phantom line. In the synthesis device 7, the above-described first electrical signal is synthesized from the above-described communication signal and an additional signal input from the additional signal generation device 6.

### EXAMPLES

With reference to Examples and Comparative Examples below, the present invention is more specifically described below. The present invention is not limited to Examples and Comparative Examples in any way. The specific numeral values used in the description below, such as blending ratios (content ratios), physical property values, and parameters, can be replaced with the corresponding blending ratios (content ratios), physical property values, and parameters in the above-described “DESCRIPTION OF THE EMBODIMENT”, including the upper limit values (numeral values defined with “or less” or “less than”) or the lower limit values (numeral values defined with “or more” or “more than”).

<Frequency 28 GHz and Intensity 80 dBμV of High-frequency Signal>

### Example 1

As Example 1, an optical transmission system 1 including the following devices shown in FIG. 1 was prepared.
Electrical-optical conversion device 2: TOSA using VCSEL having a center wavelength of 850 nm
Optical transmission line 3: Multi-mode optical fiber
Optical-electrical conversion device 4: ROSA using PD
Communication signal generation device 5: Multi signal generator, model number
N5183A, manufacture by Agilent
Additional signal generation device 6: Multi signal generator, model number WF1973, manufacture by NF CORPORATION
External device 11: Spectrum analyzer, model number N9010B, manufacture by Keysight
Direct current generation device 12: Direct current source, model number 2400 Source Meter, manufacture by KEITHLEY

In Example 1, a high-frequency signal, a single CW wave, having a frequency of 28 GHz and an intensity of 80 dBμV was generated from a communication signal generation device 5. At the same time, a direct current of 8 mA was input from a direct current generation device 12 to an electrical-optical conversion device 2. Furthermore, the additional signal generation device 6 generated an additional signal having a frequency of 1 kHz and an intensity of 70 dBμV. Subsequently, using an external device 11, the variation in quality of the second electrical signal in the optical-electrical conversion device 4 was measured for 30 minutes. The variation was obtained as the difference between the maximum value and minimum value of the signal quality measured with the external device 11. The result is shown in Table 1.

### Example 2

In the same manner as Example 1, the variation was measured. However, the frequency of the additional signal was changed from 1 kHz to 10 KHz. The result of the variation is shown in Table 1.

### Example 3

In the same manner as Example 1, the variation was measured. However, the frequency of the additional signal was changed from 1 kHz to 100 kHz. The result is shown in Tables 1 and 2.

### Example 4

In the same manner as Example 1, the variation was measured. However, the frequency of the additional signal was changed from 1 kHz to 300 kHz. The result of the variation is shown in Table 1.

### Example 5

In the same manner as Example 1, the variation was measured. However, the frequency of the additional signal was changed from 1 kHz to 500 kHz. The result of the variation is shown in Table 1.

### Comparative Example 1

In the same manner as Example 1, the variation was measured. However, an additional signal was not generated in the additional signal generation device 6. The result of the variation is shown in Table 1.

### Comparative Example 2

In the same manner as Example 1, the variation was measured. However, the frequency of the additional signal was changed from 1 kHz to 10 MHz.

### Examples 6 to 9

### <Frequency 28 GHz of High-frequency Signal>

### Example 6

In the same manner as Example 3, the variation was measured. However, in the additional signal generation device 6, the intensity of the additional signal was changed from 70 dBμV to 30 dBμV. The result of the variation is shown in Table 2.

### Example 7

In the same manner as Example 3, the variation was measured. However, in the additional signal generation device 6, the intensity of the additional signal was changed from 70 dBμV to 50 dBμV. The result of the variation is shown in Table 2.

### Example 8

In the same manner as Example 3, the variation was measured. However, in the additional signal generation device 6, the intensity of the additional signal was changed from 70 dBμV to 85 dBμV. The result of the variation is shown in Table 2.

### Example 9

In the same manner as Example 3, the variation was measured. However, in the additional signal generation device 6, the intensity of the additional signal was changed from 70 dBμV to 90 dBμV. The result of the variation is shown in Table 2.

### Example 10

In Example 10, a direct current of 8 mA was generated from the direct current generation device 12. Furthermore, the additional signal generation device 6 generated an additional signal having a frequency of 10 KHz and an intensity of 70 dBμV. However, a communication signal was not generated in the communication signal generation device 5. Subsequently, using the external device 11, the variation in the second electrical signal in the optical-electrical conversion device 4 was measured for 30 minutes. The variation was obtained as the difference between the maximum value and minimum value of the noise intensity at 28 GHz, which were 16 measured with the external device 11. The result is shown in Table 3.

Thereafter, the variation was measured. The result of the variation is shown in Table 3.

### Comparative Example 3

In the same manner as Example 10, the variation was measured. However, an additional signal was not generated in the additional signal generation device 6. In other words, a communication signal was not generated in the communication signal generation device 5, nor was an additional signal generated in the additional signal generation device 6. Subsequently, using the external device 11, the variation in the second electrical signal in the optical-electrical conversion device 4 was measured for 30 minutes. The variation was obtained as the difference between the maximum value and minimum value of the noise intensity at 28 GHz, which were measured with the external device 11. The result is shown in Table 3.

TABLE 1

| | |
|---|---|
| Frequency of | |
| additional signal | Variation(dB) |

| | | | |
|---|---|---|---|
| Ex. 1 | 1 | kHz | 0.7 |
| Ex. 2 | 10 | kHz | 0.3 |
| Ex. 3 | 100 | kHz | 1.4 |
| Ex. 4 | 300 | kHz | 0.5 |
| Ex. 5 | 500 | kHz | 2.0 |

| | | |
|---|---|---|
| Comp. Ex. 1 | — * 1 | 2.3 |

| | | | |
|---|---|---|---|
| Comp. Ex. 2 | 10 | MHz | 2.4 |

* 1: No additional signal

TABLE 2

| | Intensity of additional | |
|---|---|---|
| | signal (dB μV) | Variation(dB) |
| Ex. 6 | 30 | 1.9 |
| Ex. 7 | 50 | 1.5 |
| Ex. 3 | 70 | 1.4 |
| Ex. 8 | 85 | 3.5 |
| Ex. 9 | 90 | 4.2 |

TABLE 3

| | Additional signal | Variation(dB) |
|---|---|---|
| Ex. 10 | Presence | 1 |
| Comp. Ex. 3 | Absence | 2 |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The optical transmission system is used for optical transmission.

### DESCRIPTION OF REFERENCE NUMERALS

1 optical transmission system
2 electrical-optical conversion device
3 optical transmission line
4 optical-electrical conversion device
5 communication signal generation device
6 additional signal generation device

1. An optical transmission system that converts a first electrical signal to an optical signal, transmits the converted optical signal, and converts the transmitted optical signal to a second electrical signal, the optical transmission system comprising:
an electrical-optical conversion device that converts the first electrical signal to the optical signal;
an optical transmission line that transmits the optical signal converted in the electrical-optical conversion device; and
an optical-electrical conversion device that converts the optical signal transmitted from the optical transmission line to the second electrical signal,
wherein the first electrical signal includes a communication signal having a high frequency of more than 10 GHz and 100 GHz or less,
wherein the optical transmission system further includes an additional signal generation device that generates a low-frequency additional signal having a frequency of 1 Hz or more and 9 MHz or less, and
wherein the electrical-optical conversion device converts the first electrical signal including the additional signal generated in the additional signal generation device and the communication signal to the optical signal.

2. The optical transmission system according to claim 1, wherein the additional signal has an intensity of 70 dBμV or less.

3. The optical transmission system according to claim 1- or 2, further comprising:
a communication signal generation device that generates the communication signal.

4. An optical transmission method of converting a first electrical signal to an optical signal, transmitting the converted optical signal, and converting the transmitted optical signal to a second electrical signal,
wherein the first electrical signal includes a communication signal having a high frequency of more than 10 GHz and 100 GHz or less,
wherein the optical transmission method further includes:
a first step of converting the first electrical signal to the optical signal;
a second step of transmitting the optical signal converted in the first step;
a third step of converting the optical signal transmitted in the second step to the second electrical signal; and
a fourth step of generating a low-frequency additional signal having a frequency of 1 Hz or more and 9 MHz or less, and
wherein in the first step, the first electrical signal including the additional signal generated in the fourth step and the communication signal is converted to the optical signal.

5. The optical transmission method according to claim 4, wherein the additional signal has an intensity of 70 dBμV or less.

6. The optical transmission method according to claim 4, further comprising:
a fifth step of generating the communication signal.

7. The optical transmission system according to claim 2, further comprising:
a communication signal generation device that generates the communication signal.

8. The optical transmission method according to claim 5, further comprising:
a fifth step of generating the communication signal.
